(19) United States
(12) Patent Application Publication
(10) Pub. No.: US 2005/0266296 A1
(43) Pub. Date: Dec. 1, 2005

(54) Stack having improved cooling structure and fuel cell system having the same

(76) Inventors: Seong-Jin An, Suwon-si (KR); Hyoung-Juhn Kim, Suwon-si (KR); Yeong-Chan Eun, Suwon-si (KR); Sung-Yong Cho, Suwon-si (KR); Hae-Kwon Yoon, Suwon-si (KR); Jan-Dee Kim, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/136,859

(22) Filed: May 24, 2005

(30) Foreign Application Priority Data
May 25, 2004 (KR) 10-2004-0037281

(51) Int. Cl. H01M 8/00

(52) U.S. Cl. 429/38; 429/12; 429/34; 429/26; 429/39; 429/129

(57) ABSTRACT

A fuel cell system includes a fuel supply unit for supplying fuel, an air supply unit for supplying air, a coolant supply unit for supplying coolant, and a stack having an electricity generator in which separators are disposed on both surfaces of a membrane-electrode assembly so as to generate electric energy through an electrochemical reaction between hydrogen and oxygen supplied from the fuel supply unit and the air supply unit. The stack includes a plurality of cooling channels through which a coolant is supplied from the coolant supply unit. The cooling channels include contact-area extension surfaces for increasing the contact area of the coolant in order to provide improved cooling efficiency.

### CROSS-REFERENCE TO RELATED APPLICATION

This application claims priority to and the benefit of Korean Patent Application No. 10-2004-0037281 filed on May 25, 2004 in the Korean Intellectual Property Office, the entire content of which is incorporated herein by reference.

### FIELD OF THE INVENTION

The present invention relates to a fuel cell system and more particularly to a stack for a fuel cell having an improved cooling structure and a fuel cell system incorporating the improved stack.

### BACKGROUND OF THE INVENTION

In general, a fuel cell is an electricity generating system for directly converting chemical reaction energy into electric energy through an electrochemical reaction between hydrogen contained in hydrocarbon materials such as methanol, ethanol, and natural gas, and oxygen in air.

In particular, such a fuel cell can generate electricity through an electrochemical reaction between a fuel gas and an oxidant without combustion. Heat produced as a byproduct may be simultaneously used.

Recently developed polymer electrolyte membrane fuel cells (hereinafter referred to as a PEMFCs) have excellent output characteristics, low operation temperatures, and fast starting and response characteristics.

A PEMFC generally includes a fuel cell body, also called a stack, a fuel tank, and a fuel pump for supplying fuel to the stack from the fuel tank.

The PEMFC may further include a reformer for reforming the fuel to generate hydrogen gas which is then supplied to the stack.

In the PEMFC, the fuel stored in the fuel tank is generally supplied to the reformer by the fuel pump. Then, the reformer reforms the fuel to generate the hydrogen gas. In the stack, hydrogen and oxygen electrochemically react with each other to generate electric energy.

In such a fuel cell system, the stack generally includes a number of unit cells stacked against one another. Each unit cell has a membrane-electrode assembly (hereinafter, referred to as MEA) and a bipolar plate or separator.

Each MEA has an anode electrode and a cathode electrode arranged on the sides of an electrolyte membrane. The bipolar plate functions as a passage through which hydrogen and oxygen required for the reaction of the fuel cell are supplied to the anode electrode and the cathode electrode of the membrane-electrode assembly, and further functions as a conductor connecting the anode electrode and the cathode electrode of MEAs to each other in series.

Therefore, through the bipolar plate, the hydrogen-containing fuel is supplied to the anode electrode and oxygen or oxygen-containing air is supplied to the cathode electrode. In the process, electrochemical oxidation of fuel gas occurs in the anode electrode and electrochemical reduction of oxygen occurs in the cathode electrode. Electricity, heat, and water are obtained by the movement of electrons generated by the electrochemical reaction.

The stack of the fuel cell system should be maintained at a proper operating temperature to secure stability of the electrolyte membrane and to prevent deterioration in the performance of the electrolyte membrane.

Accordingly, the stack generally includes one or more generally smooth cooling channels to remove the heat generated from inside the stack by the flow of low-temperature air or water through the cooling channel.

### SUMMARY OF THE INVENTION

The present invention provides a stack for a fuel cell with an improved cooling channel structure that provides enhanced cooling efficiency for the stack.

In another embodiment of the present invention, a fuel cell system includes the improved stack.

According to one embodiment of the present invention, a fuel cell system is provided comprising: a stack, a fuel supply unit for supplying fuel to the stack; an air supply unit for supplying air to the stack; and a coolant supply unit for supplying coolant to the stack. The stack comprises an electricity generator in which separators are disposed on both surfaces of a plurality of membrane-electrode assemblies so as to generate electric energy through an electrochemical reaction between hydrogen and oxygen supplied from the fuel supply unit and the air supply unit. The stack includes a cooling channel through which the coolant from the coolant supply unit passes. The cooling channel includes a contact-area extension surface for increasing the contact area of the coolant within the cooling channel.

In one embodiment of the invention, the cooling channel is formed in the separators.

The stack may comprise a plurality of electricity generators and a plurality of separators with cooling channels defined by adjacent separators.

The cooling channel may be a groove formed on one surface of each separator.

The cooling channel may also be disposed on both surfaces of each separator.

The cooling channel may be formed to correspond to an inactive area in the membrane-electrode assembly.

The stack may comprise a plurality of electricity generators and the cooling channel may be formed in a cooling plate disposed between the electricity generators.

In one embodiment of the invention, the contact-area extension surface may comprise a plurality of protrusions formed on the surface of the cooling channel.

In another embodiment of the invention, the contact-area extension surface may comprise a plurality of concave indentations formed on the surface of the cooling channel.

In yet another embodiment of the invention, the contact-area extension surface may also comprise a plurality of ribs or ridges formed on the surface of the cooling channel along the longitudinal direction of the channel.

In still other embodiments of the invention, random or uneven shapes or combinations of shapes may form the contact-area extension surfaces.

According to another embodiment of the present invention, a stack for a fuel cell is provided comprising: an electricity generator having separators disposed on both surfaces of a membrane-electrode assembly; and a cooling channel which is formed by the separators and which forms a passage through which coolant for cooling the electricity generator passes. The surface of the cooling channel includes contact-area extension surfaces for improving the heat transfer efficiency of the stack.

According to another embodiment of the present invention, a stack for a fuel cell is provided comprising: an electricity generator having separators disposed on both surfaces of a membrane-electrode assembly; and a cooling plate which is connected to the electricity generator and which has a cooling channel through which coolant for cooling the electricity generator passes. The surface of the cooling channel has a contact-area extension surface for increasing the surface area and improving the heat transfer efficiency.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram schematically illustrating an entire construction of a fuel cell system according to one embodiment of the present invention;

FIGS. 2 to 4 are exploded perspective views illustrating stacks according to various embodiments of the present invention;

FIGS. 5A and 5B are views describing a contact-area extension surface according to a first embodiment of the present invention;

FIGS. 6A and 6B are views describing a contact-area extension surface according to a second embodiment of the present invention; and

FIGS. 7A and 7B are views describing a contact-area extension surface according to a third embodiment of the present invention.

### DETAILED DESCRIPTION

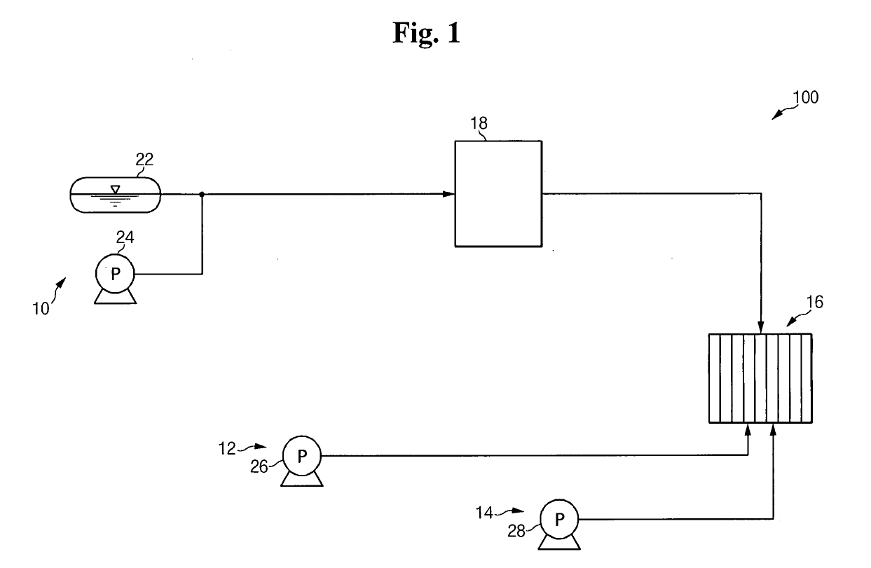

FIG. 1 is a block diagram schematically illustrating a fuel cell system according to an embodiment of the present invention.

The fuel cell system 100 employs a polymer electrode membrane fuel cell (PEMFC) scheme which generates hydrogen by reforming fuel. The hydrogen is then reacted with oxygen to produce electric energy.

In the fuel cell system 100 according to the present invention, a liquid hydrogen-containing fuel such as methanol, ethanol, or a gaseous fuel such as natural gas may be used as the fuel for generating electric energy.

As the oxygen source, pure oxygen gas may be stored in a separate storage unit and reacted with hydrogen from the fuel. Alternatively, as in the present embodiment, air may be used as the source of oxygen.

The fuel cell system 100 according to one embodiment of the present invention comprises a reformer 18 for reforming a hydrogen-containing fuel to generate hydrogen, a stack 16 for generating electric energy through an electrochemical reaction between hydrogen and oxygen, a fuel supply unit 10 for supplying the fuel to the reformer 18, and an air supply unit 12 for supplying air to the stack 16.

The fuel cell system 100 according to the present invention may also employ a direct oxidation fuel cell scheme capable of generating electric energy by directly supplying hydrogen-containing liquid fuel to the stack 16.

For a direct oxidation fuel cell, the reformer 18 shown in FIG. 1 is omitted. This distinguishes a direct oxidation fuel cell from a polymer electrode membrane fuel cell.

Hereinafter, a fuel cell system 100 employing a polymer electrolyte membrane fuel cell scheme is exemplified, but the present invention is not necessarily limited to such an embodiment.

The reformer 18 generates reformed gas from liquid fuel through a catalytic chemical reaction by means of heat energy and in addition reduces the concentration of carbon monoxide contained in the reformed gas. That is, the reformer 18 generates hydrogen-containing reformed gas from the fuel through catalytic reactions such as steam reformation, partial oxidation, and auto-thermal reactions.

Further, the reformer 18 reduces the concentration of carbon monoxide contained in the reformed gas by a catalytic reaction such as a water-gas shift reaction or a preferential oxidation reaction. The hydrogen may also be purified, for example, by using a separation membrane.

The fuel supply unit 10 includes a fuel tank 22 for storing liquid fuel and a fuel pump 24 connected to the fuel tank 22 to produce the fuel from the fuel tank 22 to the reformer.

The air supply unit 12 includes an air pump 26 for producing air to the stack 16.

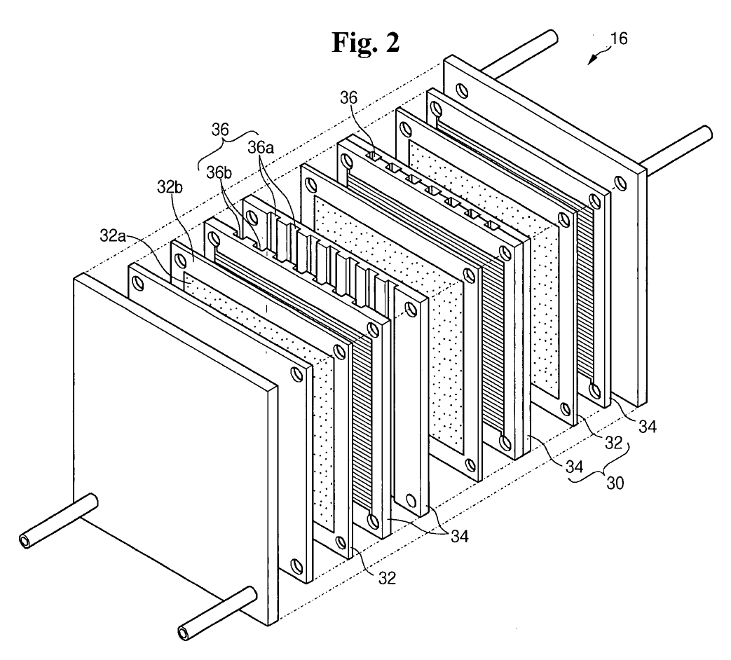

The stack 16 receives fuel from the fuel supply unit 10 and air from the air supply unit 12 and generates electric energy. FIGS. 2 to 4 are exploded perspective views of first, second, and third embodiments of stack structures.

Referring to FIG. 1, the stack 16 includes at least one electricity generator 30 for generating electric energy by reacting hydrogen supplied from the reformer 18 with air supplied from the air supply unit.

The electricity generator 30 is a unit cell for generating electric energy and includes a MEA 32 for performing oxidation/reduction of hydrogen and air and a separator (bipolar plate) 34 for supplying each of hydrogen gas and air to the MEA 32. The electricity generator 30 includes the MEA 32 and the separators 34 disposed on both sides of the MEA 32. A stack 16 is formed by arranging a plurality of electricity generators 30 in a stacked arrangement.

The MEA 32 has a conventional structure such that an electrolyte membrane is interposed between an anode electrode and a cathode electrode.

The anode electrode receives reformed gas through the separator 34 and includes a catalyst layer for separating the reformed gas into electrons and hydrogen ions, and a gas diffusion layer for the smooth transfer of electrons and reformed gas.

The cathode electrode receives air through the separator 34 and includes a catalyst layer for reacting electrons, hydrogen ions, and oxygen in air which are received from the anode electrode side, and generating water, and a gas diffusion layer for the smooth transfer of oxygen.

The electrolyte membrane is a solid polymer electrolyte whose thickness is between 50 and 200 μm and functions to encourage ion exchange by moving hydrogen ions generated from the catalyst layer of the anode electrode to the catalyst layer of the cathode electrode.

The electricity generator 30 generates electric energy and water by the following equations.
anode electrode reaction: H₂→2H+ +2e-
cathode electrode reaction: ½O₂+2H+ +2e-→H₂O
entire reaction: H₂+½O₂→H₂O+current

That is, in the anode electrode, hydrogen gas is decomposed into electrons and protons (hydrogen ions) through an oxidation reaction. The protons are moved to the cathode electrode through the electrolyte membrane and the electrons are moved to the cathode electrode of an adjacent MEA 32 through the separator 34 without being moved through the electrolyte membrane. Current is created by the flow of electrons. Furthermore, in the cathode electrode, water is produced by the moved proton and the reduction reaction of electrons and oxygen.

In the fuel cell system 100 illustrated, heat is produced in the electricity generator 30 by the oxidation/reduction reaction. Because the heat tends to dry the MEA 32, the performance of the stack 16 may deteriorate.

The fuel cell system 100 according to the embodiment of the present invention has a structure capable of removing the heat generated in the electricity generator 30 by circulating coolant inside the stack 16.

For this reason, the present system 100 includes a coolant supply unit 14 for supplying the coolant to the inside of the stack 16 and cooling channels 36 are provided in the stack 16. The coolant supply unit 14 includes a conventional coolant pump 28 for producing coolant to the electricity generator 30 within the stack 16.

In the present embodiment, the coolant may be provided as a liquid such as water. Alternatively, the coolant may be provided in a gaseous state. In one embodiment, air is used as the coolant.

The cooling channels 36 remove heat generated in the electricity generator 30 within the stack 16 through the coolant. The cooling channels 36 may be formed in various shapes and in various positions within the stack 16.

In one embodiment, each cooling channel 36 provided in the stack 16 shown in FIG. 2 is composed of first and second grooves 36a and 36b formed on adjacent surfaces of separators 34. The formed cooling channel 36 performs a cooling operation over all areas of the MEA 32, that is, an active area 32a and an inactive area 32b formed in the MEA 32 and for the whole stack 16.

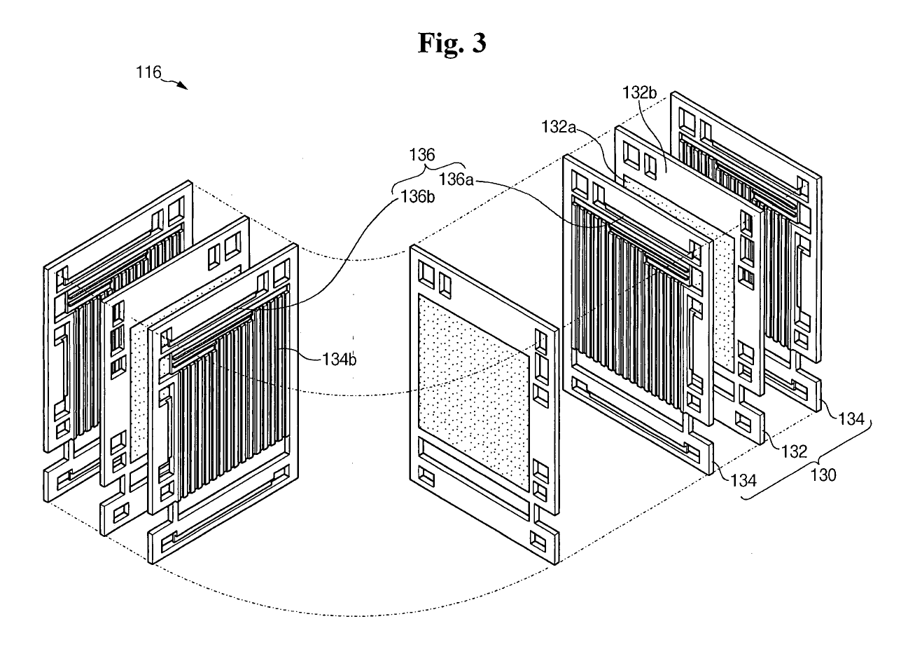

Turning to FIG. 3, another embodiment of the invention is described. Here, stack 116 is provided with a plurality of electricity generators 130, each comprising a MEA 132 and adjacent separators 134. Cooling channels 136 are provided in the stack 116, formed by first and second grooves 136a and 136b. A hydrogen transfer passage 134a and an air transfer passage 134b are formed on the sides of the separator 134 to supply hydrogen to the active area 132a of one side of the MEA 132, and air to the active area 132a of the other side of the MEA 132.

For this embodiment, the cooling channels 136 are provided around the circumference of the transfer passages 134a, 134b of each separator 134, corresponding to the inactive area 132b of the separator 134.

According to this embodiment, the cooling channel 136 cools only the inactive area 132b in the separator 134 when cooling the stack 116.

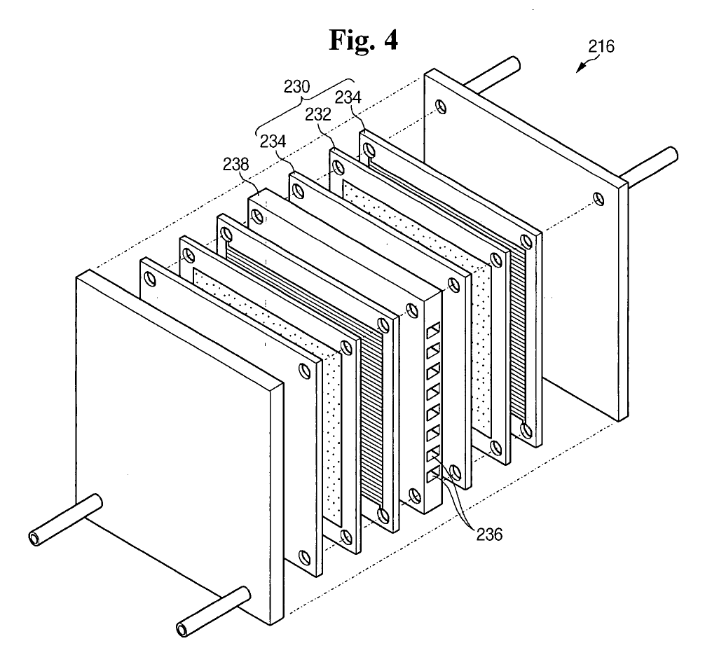

Referring now to FIG. 4, another embodiment of the invention is described. Here, stack 216 is provided with a plurality of electricity generators 230, each comprising a MEA 232 and adjacent separators 234. A cooling plate 238 is provided with cooling channels 236 provided within it. The cooling plate 238 is interposed between the electricity generators 230 formed by the MEA 232 and the separators 234 disposed on both surfaces of the MEA 232.

For this embodiment, the cooling channels 236 comprise a plurality of tunnels formed along one direction of the cooling plate 238 and within the cooling plate 238. The cooling plate 238 of this embodiment can cool all areas of the MEA 232.

Comparing the embodiments of FIGS. 2-4, those of FIGS. 2 and 3 include cooling channels 36 and 136 formed in the separators 34 and 134, while in the embodiment of FIG. 4, the cooling channels 236 are formed in a cooling plate 238.

According to an embodiment of the invention, a contact-area extension surface is formed in the cooling channels, regardless of the configuration of the cooling channels, in order to improve the cooling efficiency of the stack.

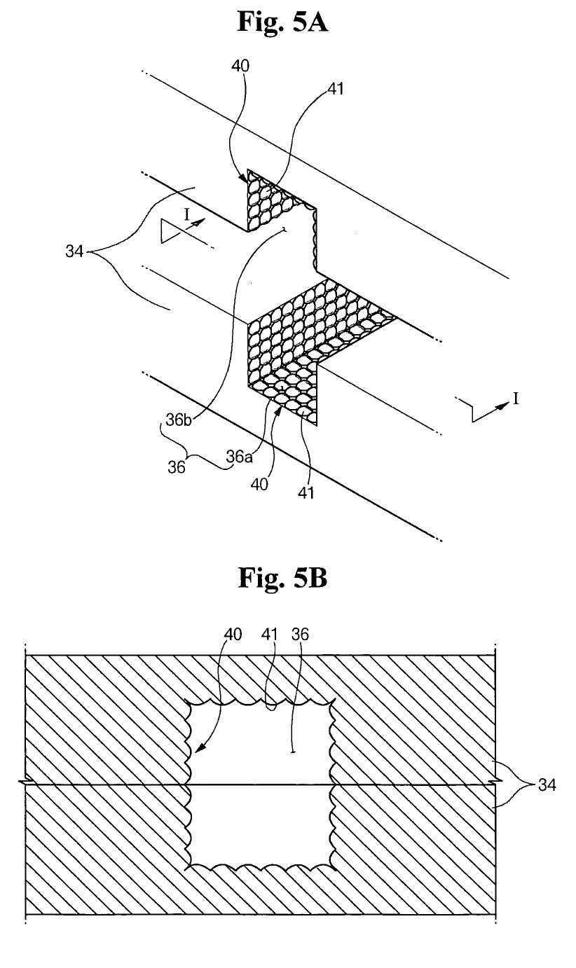

Referring now to the embodiment of the invention illustrated by FIGS. 5A and 5B, the cooling channel 36 is provided with a contact-area extension surface 40 for improving the contact area of the coolant supplied to the stack.

According to this embodiment, the contact-area extension surface 40 of the cooling channel 36 includes a plurality of protrusions 41 each having a hemisphere-shaped surface.

The protrusions 41 increase the contact area of the coolant to the surface of the cooling channel 36. For this embodiment, the protrusions 41 are of hemisphere shapes so as to not cause undue resistance in the flow of the coolant supplied to the cooling channels 36. When operating the electricity generator 30, the coolant supply unit 14 effectively helps to remove heat generated in the electricity generator 30.

The protrusions 41 increase the contact area of the coolant within the volume of the defined cooling channel 36. That is because the contact area of the coolant per unit volume of the cooling channel 36 is increased by the protrusions 41 formed on the surface of the cooling channel 36. The use of such protrusions maximizes heat transfer per unit time from the electricity generator 30, improving the cooling efficiency for the stack 16. If the contact-area extension surface is arranged corresponding to the temperature distribution within the stack 16, that is, if many contact-area extension surfaces are disposed in the high temperature regions and relatively few contact-area extension surfaces are disposed in the low temperature regions, thereby providing a proper temperature gradient, the cooling efficiency of the electricity generator 30 can be further improved.

For convenience, the contact-area extension surface 40 has been described as being formed within the cooling channel 36 provided in the stack 16 shown in FIG. 2. However, it will be apparent to one of ordinary skill in the art that it may be applied to other cooling channels such as those of the embodiments of FIGS. 3 and 4.

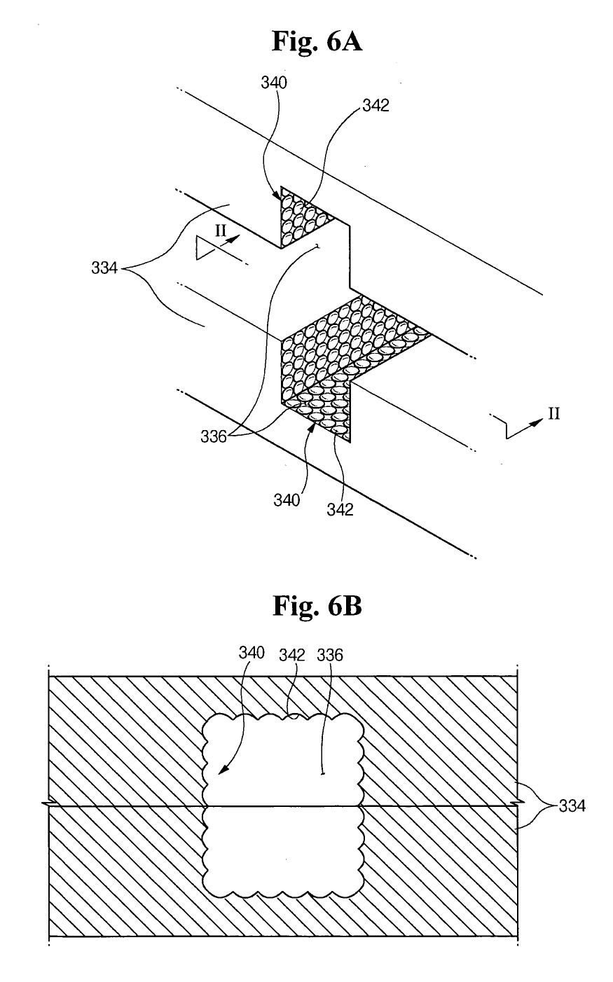

FIGS. 6A and 6B describe a contact-area extension surface 340 according to another embodiment of the present invention, where a pair of separators 334 similar to those of FIG. 2 define a cooling channel 336 that includes a contact-area extension surface 340 comprising a plurality of concave indentations 342 of a generally hemispherical shape.

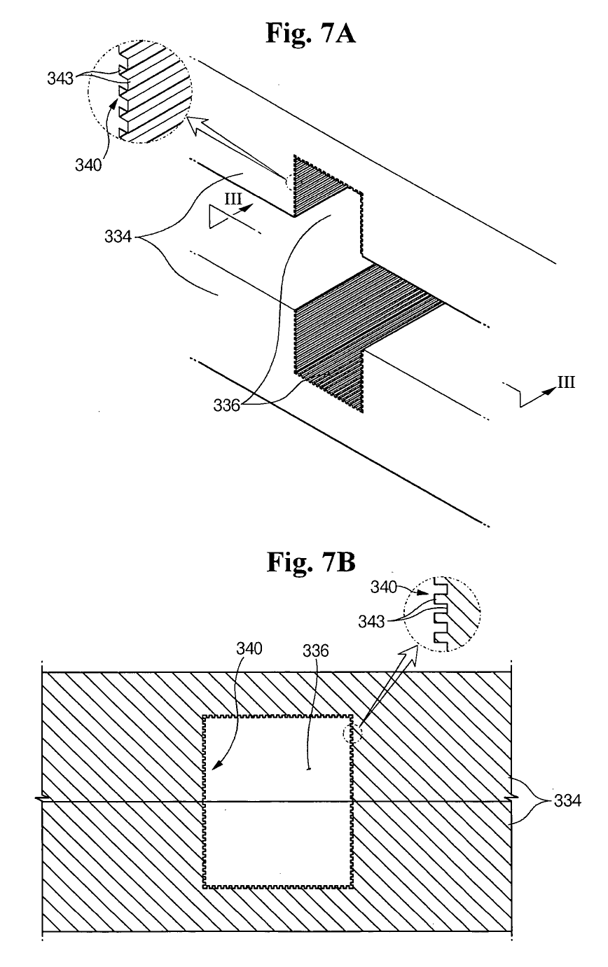

Further, FIGS. 7A and 7B describe yet another contact-area extension surface 440 according to another embodiment of the present invention, where a pair of separators 434 similar to those of FIG. 2 define a cooling channel 436 that includes a contact-area extension surface 440 comprising a plurality of ridges or ribs 443 formed along the longitudinal direction of the cooling channel 436.

While the embodiments of FIGS. 6A, 6B, 7A, and 7B have been described as being formed within cooling channels similar to those of stack 16 as shown in FIG. 2, it will be apparent to one of ordinary skill in the art that these embodiments may be applied to other cooling channels such as those of the embodiments of FIGS. 3 and 4.

The contact-area extension surface according to the present invention can be formed in various shapes in a cross-section perpendicular to the longitudinal direction of the cooling channel. Because the respective contact-area extension surfaces extend the contact area of the coolant within the cooling channel, the cooling efficiency for the stack can be improved.

While the contact-area extension surfaces have been illustrated as having patterned shapes of generally evenly spaced protrusions, indentations, or ribs covering all regions of the cooling channel, the contact-area extension surfaces may be provided as an uneven or random pattern, or a combination of surfaces may be provided.

Furthermore, the method for forming the contact-area extension surface and the specific shape of the contact-are extension surfaces may be dependent on the manufacturing process for the relevant separator or cooling plate.

If the separator is made by compression molding with powder-state carbon composite materials, the contact-area extension surfaces can be formed by machining. If the separator or the cooling plate is made with a metal material, the contact-area extension surfaces can be formed by etching.

According to a fuel cell system of the present invention, it is possible to improve cooling efficiency of the stack by forming cooling channels within the stack and providing the cooling channels with contact-area extension surfaces for increasing the contact area of the coolant in the cooling channel.

Although the exemplary embodiments and the modified examples of the present invention have been described, the present invention is not limited to the embodiments and examples, but may be modified in various forms without departing from the scope of the appended claims, the detailed description, and the accompanying drawings of the present invention. Therefore, it is natural that such modifications belong to the scope of the present invention.

1. A fuel cell system comprising:
a fuel supply unit;
an air supply unit;
a coolant supply unit; and
a stack including at least one electricity generator comprising a membrane-electrode assembly with a separator disposed on either side, the stack further including at least one cooling channel through which a coolant is supplied from the coolant supply unit, the at least one cooling channel including a surface defining a contact-area extension surface for increasing the contact area of the coolant.

2. The fuel cell system of claim 1, wherein the at least one cooling channel is defined by at least one separator.

3. The fuel cell system of claim 2, wherein the stack comprises a plurality of electricity generators and the at least one cooling channel is defined by a pair of adjacent separators.

4. The fuel cell system of claim 3, wherein the at least one cooling channel is defined by a pair of grooves, one groove on a surface of each of two adjacent separators.

5. The fuel cell system of claim 4, wherein the cooling channel is located corresponding to an inactive area of the membrane-electrode assembly.

6. The fuel cell system of claim 1, wherein the stack comprises a plurality of electricity generators separated by a plurality of cooling plates, wherein each cooling plate defines at least one cooling channel.

7. The fuel cell system of claim 1, wherein the contact-area extension surface comprises a plurality of protrusions defined by the surface of the at least one cooling channel.

8. The fuel cell system of claim 7, wherein the protrusions comprise evenly spaced hemispherical protrusions.

9. The fuel cell system of claim 1, wherein the contact-area extension surface comprises a plurality of concave indentations defined by the surface of the at least one cooling channel.

10. The fuel cell system of claim 9, wherein the concave indentations comprise evenly spaced hemispherical indentations.

11. The fuel cell system of claim 1, wherein the contact-area extension surface comprises a plurality of ribs defined by the surface of the cooling channel and extending in the longitudinal direction of the channel.

12. The fuel cell system of claim 1, wherein the contact-area extension surface is a machined surface.

13. The fuel cell system of claim 1, wherein the contact-area extension surface is an etched surface.

14. A stack for a fuel cell comprising:
at least one electricity generator comprising a membrane-electrode assembly and a separator disposed on a side of the membrane-electrode assembly; and
a cooling channel defined by the separator, the cooling channel defining a passage through which coolant flows for cooling the electricity generator, wherein the cooling channel defines a contact-area extension surface.

15. The stack of claim 14, wherein the contact-area extension surface comprises a plurality of protrusions.

16. The stack of claim 15, wherein the protrusions comprise evenly spaced hemispherical protrusions.

17. The stack of claim 14, wherein the contact-area extension surface comprises a plurality of concave indentations.

18. The stack of claim 17 wherein the concave indentations comprise evenly spaced hemispherical indentations.

19. The stack of claim 14, wherein the contact-area extension surface comprises a plurality ribs.

20. A stack for a fuel cell comprising:
at least one electricity generator comprising a membrane-electrode assembly and a pair of separators, one disposed on each side of the membrane-electrode assembly; and
at least one cooling plate adjacent the at least one electricity generator, the cooling plate defining at least one cooling channel through which coolant for cooling the electricity generator may pass, wherein the cooling channel defines a contact-area extension surface.

21. The stack of claim 20, wherein the contact-area extension surface comprises a plurality of protrusions.

22. The stack of claim 21, wherein the protrusions comprise evenly spaced hemispherical protrusions.

23. The stack of claim 20, wherein the contact-area extension surface comprises a plurality of concave indentations.

24. The stack of claim 23 wherein the concave indentations comprise evenly spaced hemispherical indentations.

25. The stack for a fuel cell of claim 20, wherein the contact-area extension surface comprises a plurality of ribs.
